(19) United States
(12) Patent Application Publication
(10) Pub. No.: US 2018/0105119 A1
(43) Pub. Date: Apr. 19, 2018

(54) HITCH MOUNT ANGLE ADJUSTABLE TRANSPORT RACK TO CARRY AN ELONGATED ITEM

(71) Applicant: MAGIC RACK LLC, Suwanee, GA (US)

(72) Inventors: Rhett Butler Spivia, Suwanee, GA (US); Frederik Penz, Braselton, GA (US)

(21) Appl. No.: 15/787,485

(22) Filed: Oct. 18, 2017

Related U.S. Application Data
(60) Provisional application No. 62/410,048, filed on Oct. 19, 2016.

(51) Int. Cl. B60R 9/06

(52) U.S. Cl. CPC B60R 9/06; B60P 3/1091

(57) ABSTRACT

A transport rack mounts to a hitch mount of a vehicle and carries an elongated item such as a canoe or ladder. The transport rack includes a support structure where the elongated item may be loaded. The support structure is coupled to rotation plates while the rotation plates are rotationally coupled to a support post that is coupled to a hitch mount post that attaches to the vehicle. The rotation plates and support structure rotate together relative to the support post to provide an adjustable angle of the elongated item being carried by the support structure. This allows an end of the elongated item to rise above an obstruction such as the rear of the vehicle to which the transport rack is attached.

### RELATED APPLICATIONS

The present application claims priority to U.S. Provisional Application No. 62/410,048 filed on Oct. 19, 2016, and entitled HITCH MOUNT ANGLE ADJUSTABLE TRANSPORT RACK TO CARRY AN ELONGATED ITEM.

### TECHNICAL FIELD

Embodiments relate to transport racks. More specifically, embodiments relate to hitch mount transport racks that have an adjustable angle.

### BACKGROUND

Transport racks for vehicles allow items to be hauled without requiring the items to be loaded inside of the vehicle and without requiring the vehicle to pull a trailer to carry such items. Generally, the transport racks mount to the vehicle's hitch mount. The transport racks are therefore generally in close proximity to the rear of the vehicle. Furthermore, conventional transport racks typically haul the items in a horizontal position.

While conventional transport racks are very useful, the proximity of the rack to the rear of the vehicle may present various issues. For instance, elongated items such a ladders and kayaks in a horizontal position may need to extend a significant distance forward in the direction of the vehicle from the transport rack. If the rear of the vehicle has a height that reaches the height of the elongated item when loaded on the transport rack, the elongated item will be blocked by the vehicle from being properly loaded. This conflict eliminates the ability to haul such elongated items on a conventional transport rack.

### SUMMARY

Embodiments address issues such as these and others by providing a hitch mount transport rack that includes the ability to rotate the support structure that the elongated item rests upon. In such a way, the elongated item is held on the support structure at selectable angle, rather than horizontal, such that the elongated item may extend over the read of the vehicle. Embodiments may also address a similar issue but where the read of the elongated item needs to be raised in order to extend over an item that may be present behind the transport rack.

Embodiments provide an apparatus that can be affixed to a vehicle hitch mount to carry an elongated item. The apparatus includes a support post and a hitch mount post coupled to the support post at an angle. The apparatus further includes a rotation plate rotationally coupled to the support post. Additionally, the apparatus includes a support structure coupled to the rotation plate such that the support structure and rotation plate rotate together relative to the support post.

Embodiments provide a method of making an apparatus that can be affixed to a vehicle hitch mount to carry an elongated item. The method involves providing a support post coupled to a hitch mount post at an angle and rotationally coupling a rotation plate to the support post. The method further involves coupling a support structure to the rotation plate such when the rotation plate is rotationally coupled to the support post, the support structure and rotation plate rotate together relative to the support post.

Embodiments provide a method of using an apparatus that can be affixed to a vehicle hitch mount to carry an elongated item, wherein the apparatus comprises a support post; a hitch mount post coupled to the support post at an angle; a rotation plate rotationally coupled to the support post; and a support structure coupled to the rotation plate such that the support structure and rotation plate rotate together relative to the support post. The method involves coupling the hitch mount post to the vehicle hitch mount and setting the support structure together with the rotation plate to a rotational position relative to the support post. The method also involves locking the rotational position of the rotation plate relative to the support post.

### DESCRIPTION OF THE DRAWINGS

It will be appreciated that the following description of the multiple views follows the orthogonal view drafting convention.

FIG. 1A shows a side view of an embodiment of a transport rack that is attached to a vehicle and carrying an elongated item with a raised forward end to clear the vehicle.

FIG. 1B shows a side view of an embodiment of a transport rack that is attached to a vehicle and carrying an elongated item in a vertical position with an additional accessory attached to provide a floor.

FIG. 1C shows a side view of an embodiment of a transport rack that is attached to a vehicle and carrying an elongated item with a lowered forward end to clear an object on a rearward accessory.

FIG. 2 shows a rear-left downward facing perspective view of an embodiment, where the rear view is considered to be the view when looking from the rear of a vehicle toward the transport rack when the transport rack is attached to the vehicle.

FIG. 3 shows a front-right downward facing perspective view of the embodiment, where the front view is considered to be the view when looking forward from behind the transport rack when the transport rack is attached to a vehicle.

FIG. 4 shows a right side view of the embodiment.

FIG. 5 shows the front view of the embodiment.

FIG. 6 shows a left side view of the embodiment.

FIG. 7 shows the rear view of the embodiment.

FIG. 8 shows a top view of the embodiment.

FIG. 9 shows a bottom view of the embodiment.

FIG. 10 shows a side view of an example of a first non-horizontal rotational position of the embodiments.

FIG. 11 shows a side view of an example of a second non-horizontal rotational position of the embodiments.

FIG. 12 shows a side view of an example of a third non-horizontal rotational position of the embodiments.

FIG. 13 shows a side view of an example of a fourth non-horizontal rotational position of the embodiments.

FIG. 14 shows an exploded perspective view of the embodiment.

FIG. 15 shows a side view of a hitch mount post and tightening plate of the embodiment coupled to a hitch mount of a vehicle.

FIG. 16 shows a cross-sectional view of the hitch mount post and tightening plate of the embodiment.

### DETAILED DESCRIPTION

Embodiments provide a transport rack that includes one or more rotation plates rotationally coupled to an end of a vertical support post and coupled to a support structure for holding an elongated item. The rotation plate, and the support structure coupled to the rotation plate, rotate about a pivot point of the rotational coupling of the rotation plate to the vertical support post. This rotation of the support structure allows the front or rear of the elongated item to be placed in an elevated position as needed to clear any obstruction in front of, or behind the transport rack such as the vehicle to which the transport rack is attached.

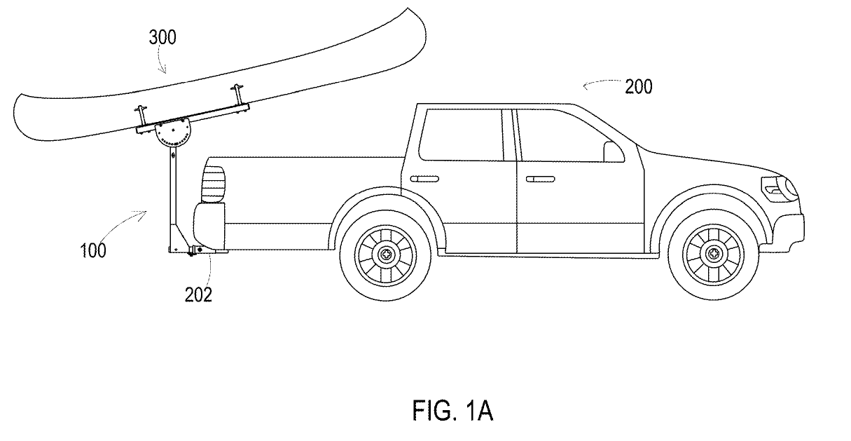

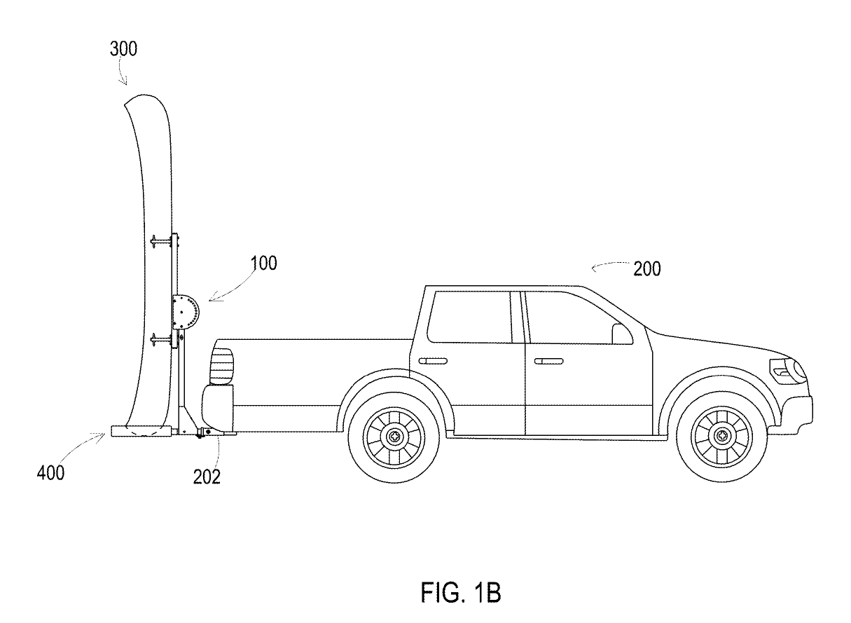

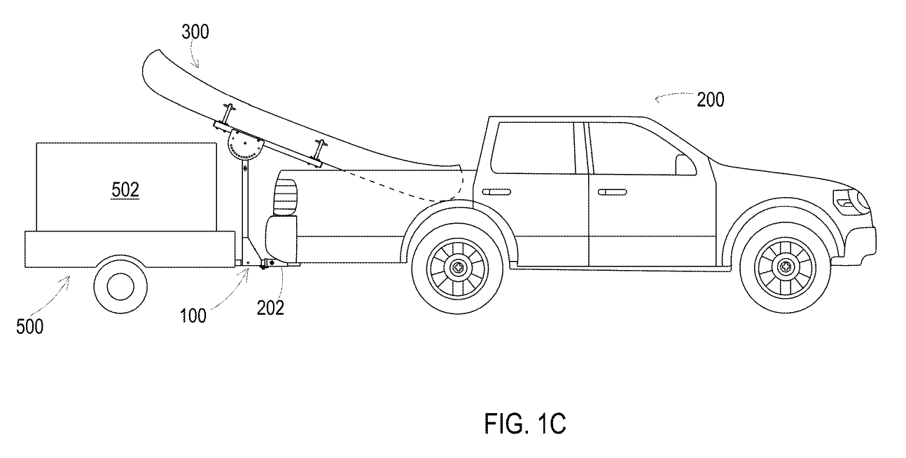

FIG. 1A shows a vehicle 200 with a hitch mount 202 and an embodiment of a transport rack 100 that is coupled to the hitch mount 202. An elongated item 300, specifically a canoe in this example, is loaded on the transport rack 100. As can be seen in this example, the elongated item 300 cannot rest in a horizontal position due to interference with the rear of the vehicle 200. However, the transport rack 100 is configured such that the elongated item 300 is held at an angle that allows the front of the elongated item 300 to rise above the rear of the vehicle. The elongated item 300 may be secured in place on the transport rack with ropes, straps, cords, or other such items (not shown).

Embodiments of the transport rack 100 allow for various configurations such as the one shown in FIG. 1A to accommodate a number of situations where the elongated item cannot be loaded in a horizontal position. For instance, it may be desirable to have a hauling accessory 400 attached to the transport rack 100 as shown in FIG. 1B where the elongated item 300 is held in a vertical position and rests on a floor established by the hauling accessory 400. In yet another situation as shown in FIG. 1C, a second transport rack or other accessory such as a trailer 500 is attached to the rear of the transport rack 100, where an elongated item 300 on the transport rack 100 may not be restricted by the rear of the vehicle 200 but where the rear of the elongated item 300 is instead restricted by the object 502 on the second transport rack or trailer 500. In such a case, the transport rack 100 may be configured to raise the rear of the elongated item 300. These various configurations of the transport rack 100 and the construction of the transport rack 100 that provides for these various configurations are discussed in more detail below.

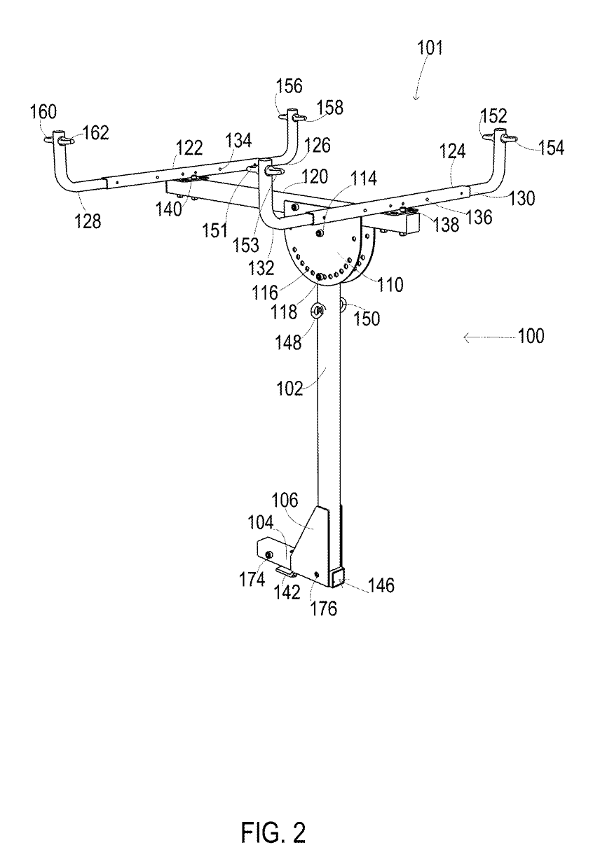

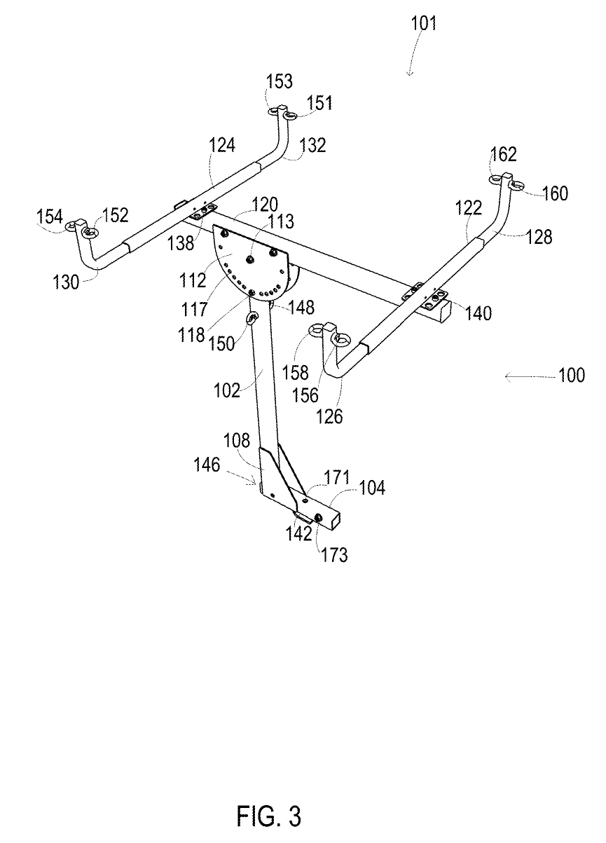

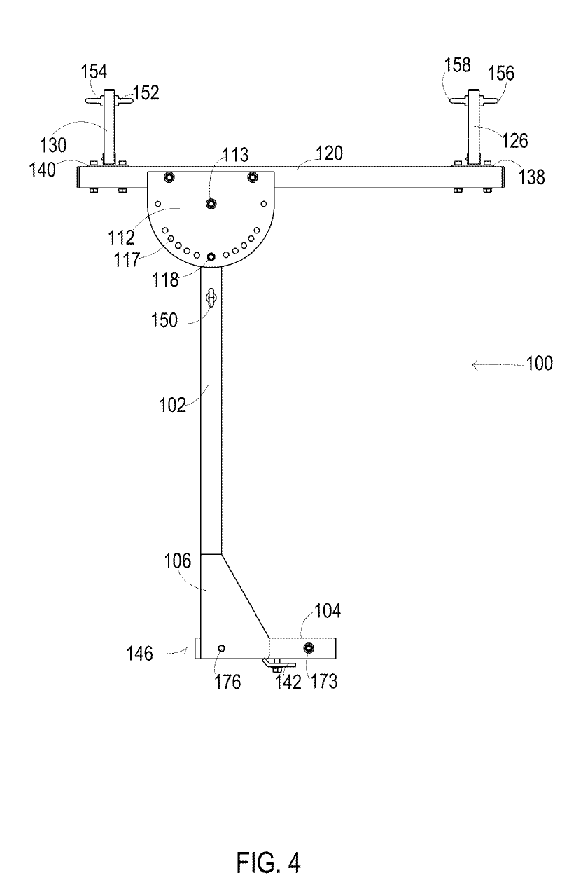

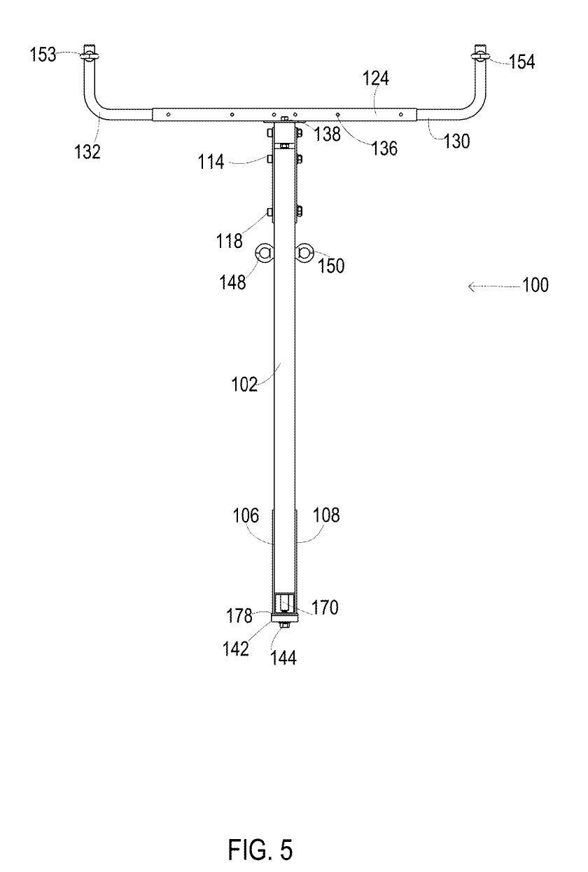

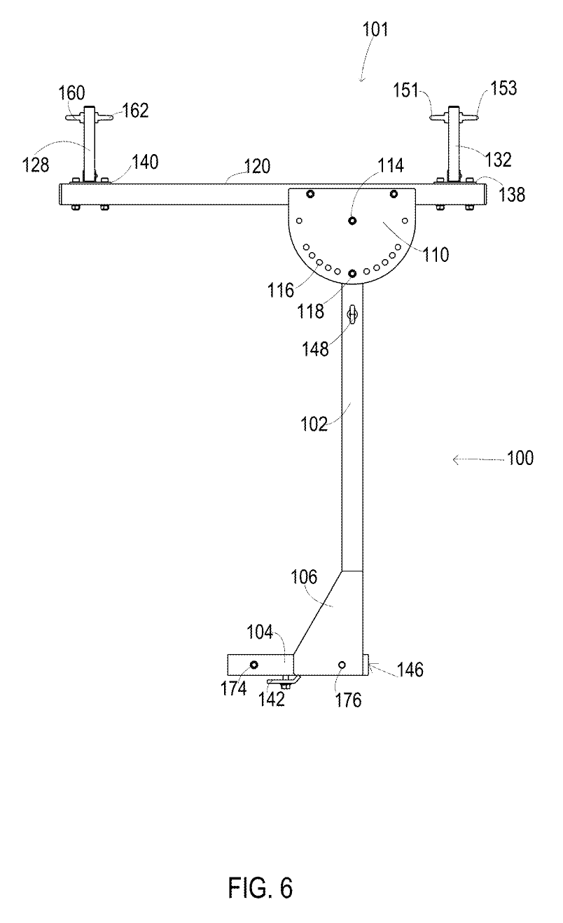

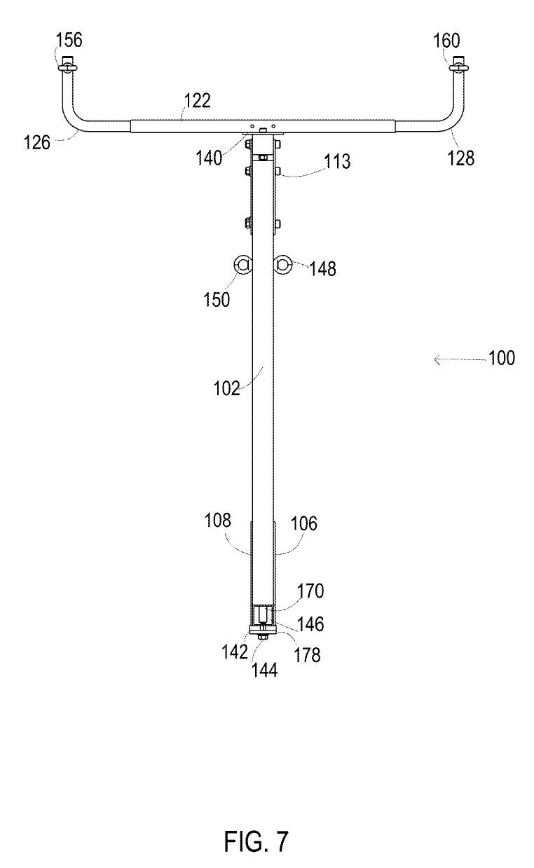

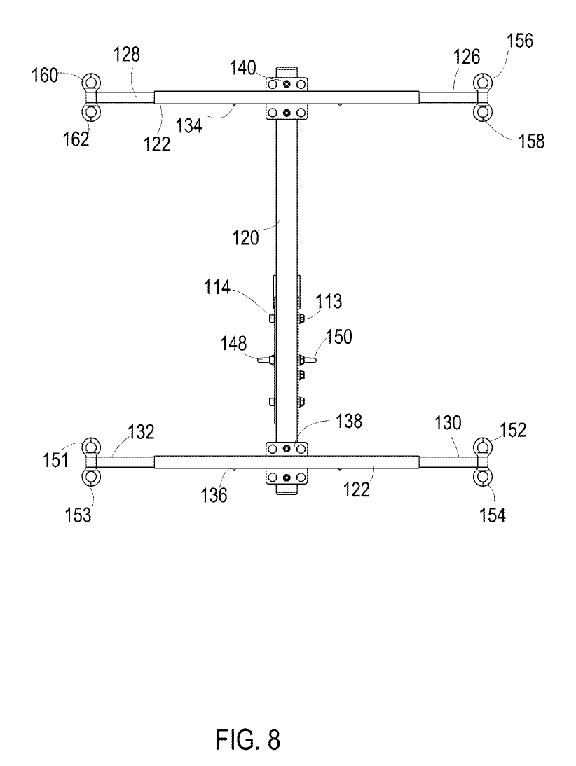

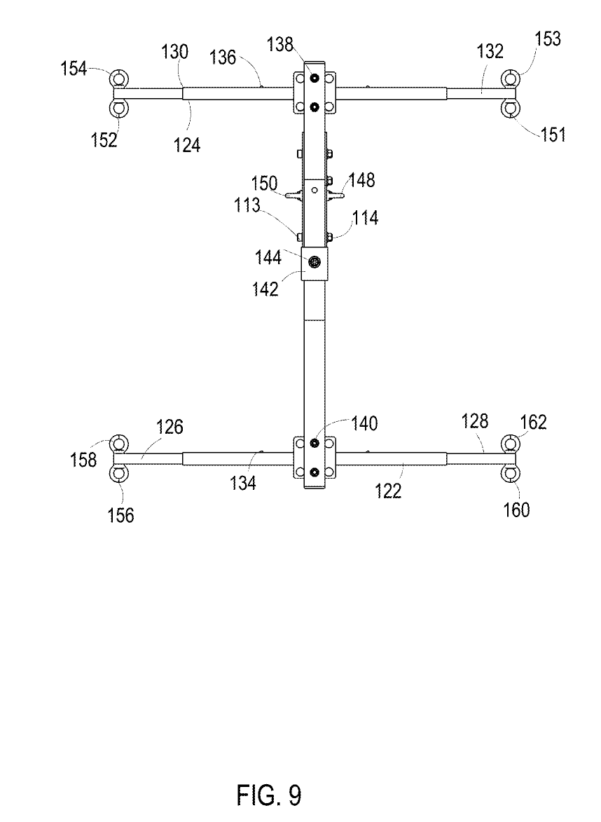

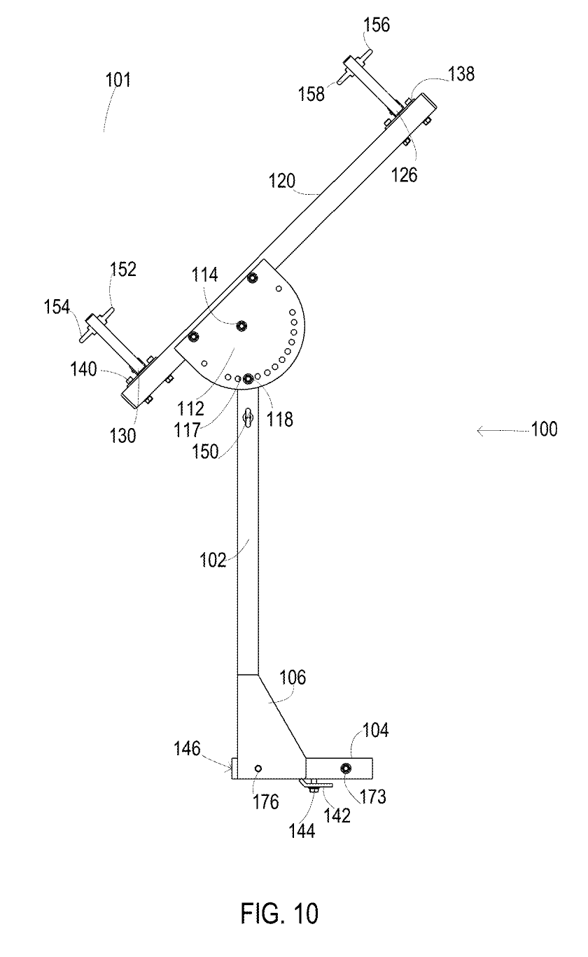

FIGS. 2 and 3 are perspective views of the embodiment of the transport rack 100, while FIGS. 4-9 are the major views. In these views, it can be seen that the transport rack 100 includes a support structure 101 where the elongated item to be hauled may be loaded. In these figures, the support structure 101 is positioned to provide a horizontal loading of the elongated item. However, the transport rack 100 provides the ability to rotate the support structure 101 to positions other than the horizontal, such as the position shown in FIG. 1, while the transport rack 100 remains coupled to the hitch mount 202 of the vehicle 200. FIGS. 10-13 show some of the positions of the support structure 101 that are possible according to various embodiments.

Embodiments of the transport rack 100 include a hitch mount post 104 that is received by the hitch mount 202 of the vehicle 200. The hitch mount post 104 is coupled to a support post 102. In the embodiment shown, the support post 102 is shown as having a longitudinal dimension that is approximately perpendicular to a longitudinal dimension of the hitch mount post 104, but it will be appreciated that the longitudinal axis of the support post may be at an angle other than perfectly 90 degrees relative to that of the hitch mount post 104.

Examples shown in the figures use the convention that the hitch mount post 104 is generally horizontal and the coupling to the support post 102 provides the support post 102 at an approximately 90 degree angle to the hitch mount post 104 such that the support post 102 in these examples may be considered to be generally vertical and is referred to herein as a vertical support post 102 with respect to the examples shown for that reason. However, as the support post 102 may be coupled to the hitch mount post at an angle other than perpendicular, it will be appreciated that the support post 102 being in a vertical orientation is just one example and other orientations besides vertical are also applicable.

Likewise, the vertical support post 102 may be other than perfectly vertical even when the coupling to the hitch mount post 104 provides a perpendicular configuration, particularly when viewed while the transport rack 100 is mounted to certain vehicles where the hitch mount post 104 is other than horizontal. However, in the example shown in the figures, the vertical support post 102 is oriented in a generally vertical position while the hitch mount post 104 is oriented in a generally horizontal position.

The vertical support post 102 may be coupled to the hitch mount post 104 in various ways. For instance, the vertical support post 102 may be bolted to the hitch mount post 104 or welded to the hitch mount post 104. In another example, the vertical support post 102 may be unitary with the hitch mount post 104, where the coupling takes the form of a transition bend in the material forming both posts. Furthermore, the coupling between the hitch mount post 104 and support post 102 may be a direct coupling where each contacts the other as shown or even indirect where there may be intervening structures.

In the embodiment shown, the vertical support post 102 and the hitch mount post 104 are separate posts with support plates 106, 108 attached thereto to provide a stable coupling which reduces the likelihood of the vertical support post 102 swaying relative to the hitch mount post 102. These support plates 106, 108 may be coupled to the vertical support post 102 and the hitch mount post 104 in various ways, such as being bolted to each of the posts and/or welded to each of the posts.

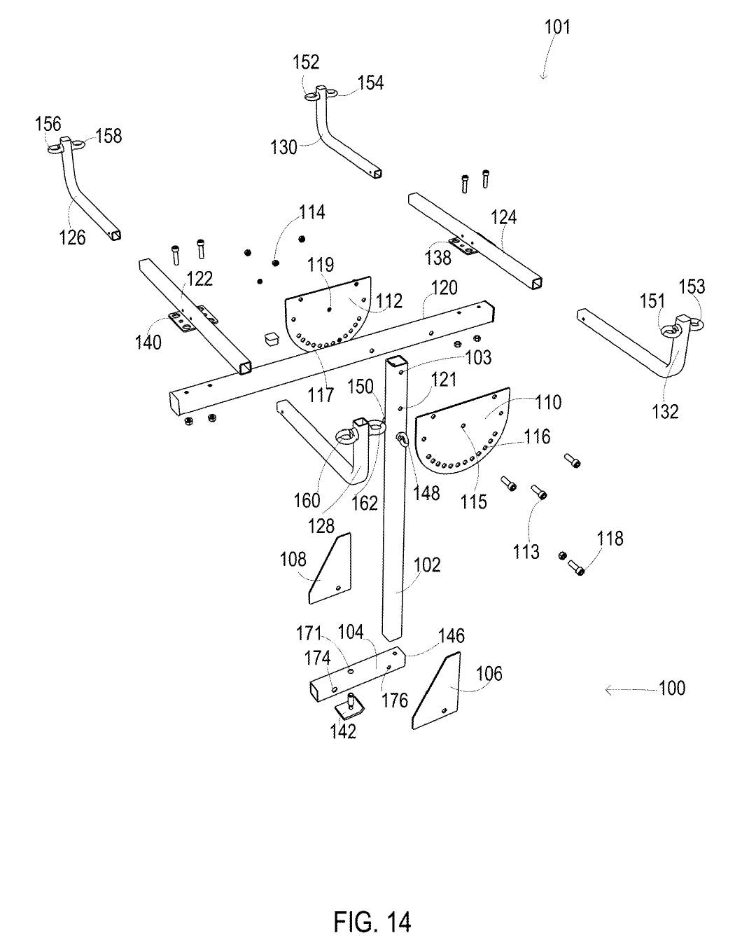

On the end of the vertical support post 102 that is opposite the hitch mount post 104, one or more rotation plates 110, 112 are rotationally coupled to the vertical support post 102. In the example shown, the vertical support post 102 has a pivot hole 103, which can be seen in the exploded view of FIG. 14. The one or more rotation plates 110, 112 have a centerpoint hole 115, 119, also visible in the exploded view of FIG. 14, that are aligned with the pivot hole 103. A pivot bolt 114, engaging a corresponding nut 113, passes through the centerpoint holes 115, 119 of the rotation plates 110, 112 and through the pivot hole 103 of the vertical support post 102. This allows the one or more rotation plates 110, 112 to be rotationally coupled to the vertical support post 102 so that the rotation plates 110, 112 rotate about the pivot bolt 114 and thus rotate relative to the vertical support post 102 while remaining coupled to the vertical support post 102. In the particular example shown in the figures, there are two rotation plates 110, 112 with the vertical support post 102 being positioned between the two rotation plates 110, 112. Using both rotation plates 110, 112 to provide a rotation plate on each side of the vertical post 102 provides a rotational coupling with increased stability for the support structure 101.

The support structure 101 discussed above is rigidly coupled to the one or more rotation plates 110, 112. While the support structure 101 may be provided in many forms, shapes, and types, in the example shown, the support structure 101 includes a center post 120 that is coupled to the rotation plates 110, 112 so that the center post 120 rotates together with the rotation plates 110, 112 as the rotation plates 110, 112 rotate about the pivot bolt 114. This rigid coupling of the support structure 101 to the rotation plates 110, 112 may be done in various ways such as by bolting and/or welding the support structure 101, and specifically the center post 120 in the example shown, to the rotation plates 110, 112.

The support structure 101 of this example further includes a front cross-member 122 coupled to the front end of the center post 120 and a rear cross-member 124 coupled to the rear end of the center post 120. It will be appreciated that any number of cross-members may be used. The cross-members 122, 124 may be coupled to the center post 120 in various ways, such as being bolted or welded directly. In the example shown, the cross-members 122, 124 are welded to mounting plates 140, 138, respectively. The mounting plates 140, 138 are then bolted or welded to the center post 120. The cross-members 122, 124 of this example effectively provide a floor for elongated items to be loaded upon. These cross-members 122, 124 rotate together with the center post 120 to the desired angle relative to the vertical support post 120.

To complete this example of a support structure, L-shaped catches 126, 128, 130, and 132 are present on each end of each cross-member 122, 124. These L-shaped catches constrain the position of the elongated item on the support structure 101. In some embodiments, the L-shaped catches may be statically coupled to the cross-members 122, 124, such as where the catches are unitary with the cross-members 122, 124. Alternatively, the L-shaped catches 126, 128, 130, and 132 may have adjustable positions so as to give the support rack 101 an adjustable width to accommodate loads of different widths. In the example shown, the L-shaped catches include spring loaded buttons that engage holes 134, 136 of the cross-members 122, 124. Adjusting the width simply involved positioning the spring-loaded button into a different hole of the cross-members 122, 124. It will be appreciated that other manners of adjusting the L-shaped catch are also applicable, such as using bolts that pass through holes in the L-shaped catch and the corresponding cross-member.

Adjusting the rotational position of the rotation plates 110, 112 together with the support structure 101 relative to the vertical support post 102 may be done manually by pulling the support structure to the desired angle. This position be locked in various ways. As one example, the support structure can be tied in place relative to the vertical support post 102. For instance, eyelets 148, 150 on the vertical support post 102 may be tied to the cross-members 122, 124 and/or the L-shaped catches which may also include eyelets 151, 153, 152, 154, 156, 158, and 160, 162. However, in the example shown, an alternative manner of locking the position is to include a series of adjustment holes 116, 117 in the rotation plates 110, 112 while having a locking hole 121 in the vertical support post 102. The rotation plates 110, 112 and support structure 101 are rotated until an adjustment hole 116, 117 in each of the rotation plates 110, 112 aligns with the locking hole 121 of the vertical support post 102. A locking pin 118 is then placed through those aligned holes to lock the rotational position of the rotation plates 110, 112 and support structure 101. A clip or similar structure may hold the pin 118 in place, or as an alternative, a nut and bolt can be used instead.

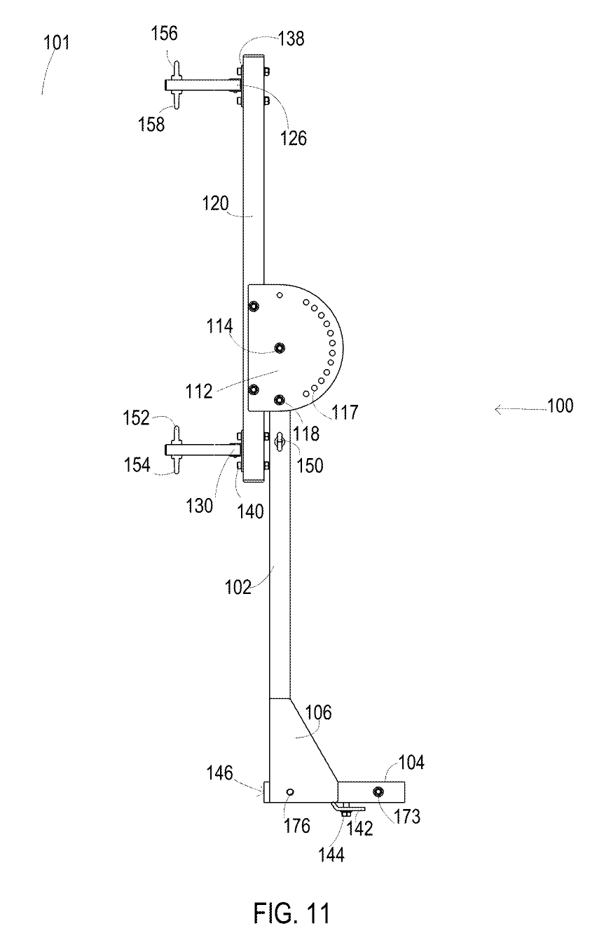

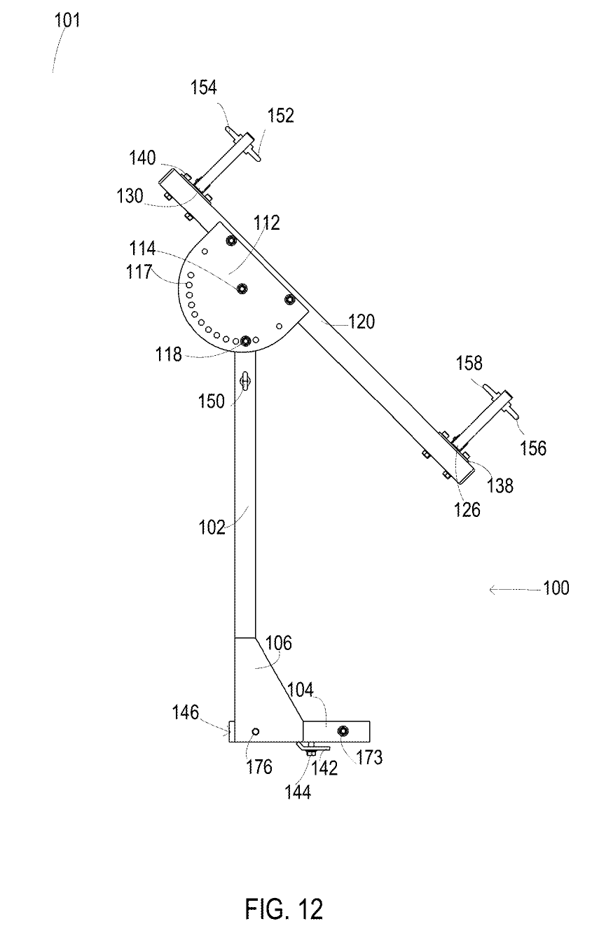

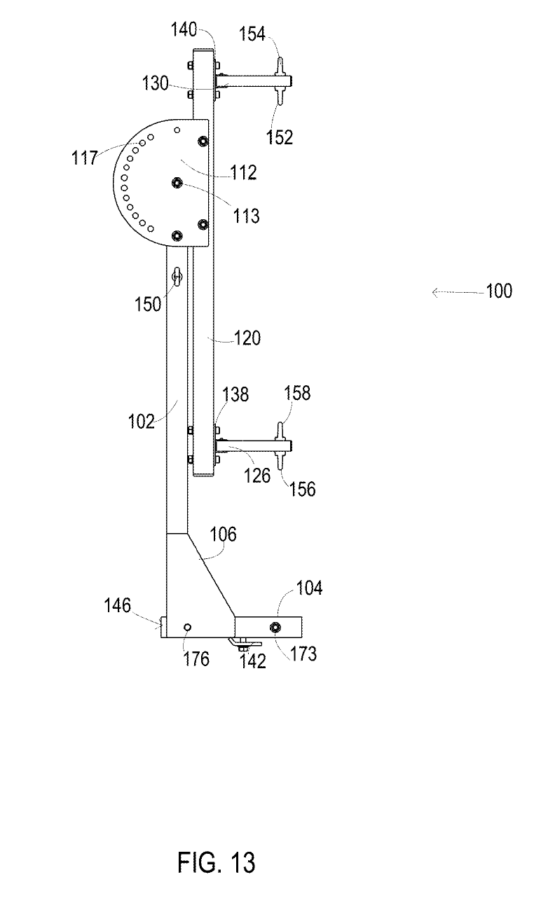

The number of adjustment holes 116, 117 can vary depending upon the number of lockable rotation positions are desired. In the example shown, there are adjustment holes 116, 117 that span all the way to +/−90 degrees from horizontal. This allows the support structure to raise the end closest to the vehicle or raise the end farthest from the vehicle, depending upon the circumstances. This is illustrated in FIGS. 10-13, where the rotation plates are locked in +/−45 degrees from horizontal in FIGS. 10 and 12, respectively, and +/−90 degrees from horizontal in FIGS. 11 and 13, respectively. There are several other adjustment hole positions allowing for several other lockable angled positions.

In order to provide these lockable positions, the adjustment holes 116, 117 are provided in a series to form an arc. The centerpoint holes 115, 119 are the centerpoint of a radius formed by the arc in addition to being the centerpoint of rotation of the rotation plates 110, 112. This ensures that as the rotation plates 110, 112 rotate about the pivot bolt 114 passing through the centerpoint holes 115, 119, each adjustment hole 116, 117 of the arc will align with the locking hole 121.

In addition to purposes discussed above, the several eyelets 151, 153, 152, 154, 156, 158, and 160, 162 may be included to assist in securing the elongated item to the support structure. As discussed above in relation to FIG. 1, a rope or other cord (not shown) may be used to tie the elongated item 300 to the eyelets. This allows the support structure 101 to be positioned at an angle other than horizontal without the elongated item falling from the support structure. The angle of the support structure 101 may be adjusted from horizontal while the elongated item is present on the support structure 101, or the elongated item may be placed on the support structure 101 after the rotational angle of the support structure 101 has been set. In either case, the elongated item is tied in place on the support structure 101. Furthermore, embodiments may provide other features of the support structure 101 beyond those shown. For instance, the support structure may provide forward and/or rear L-catches or other structures to prevent the elongated item from sliding off of the support structure 101.

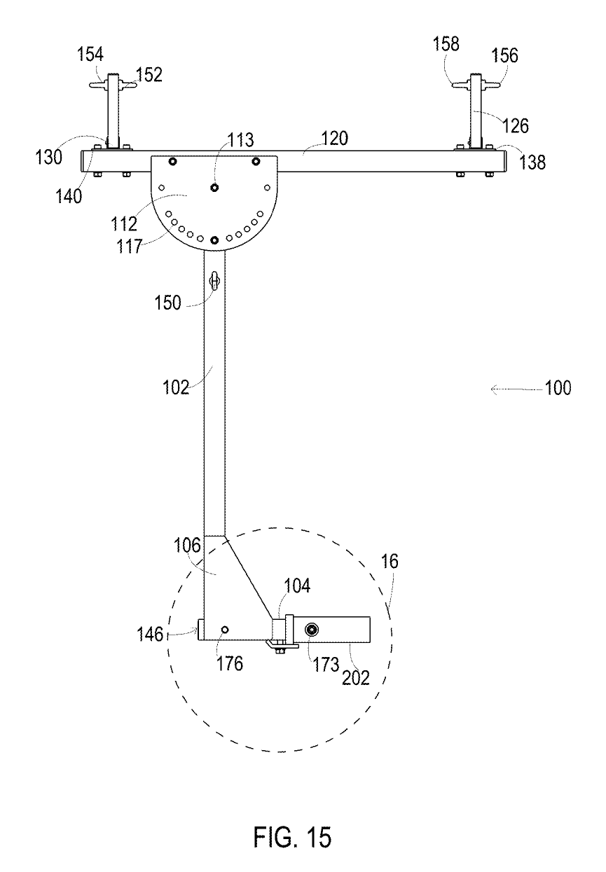

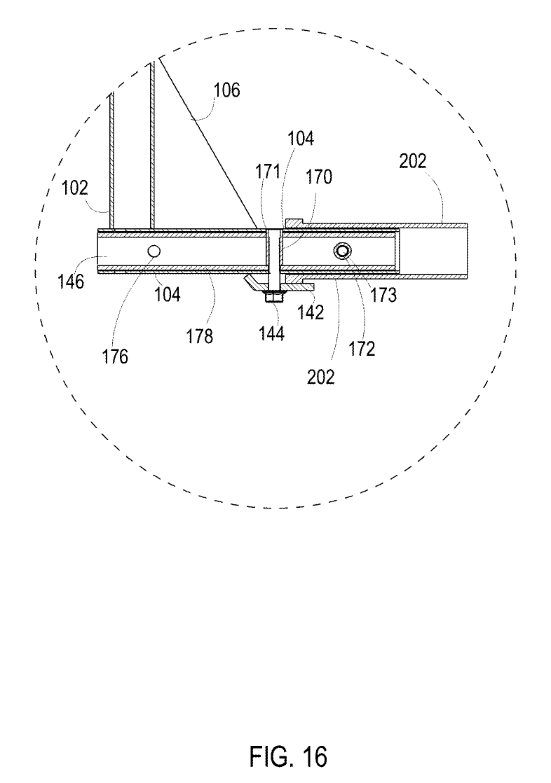

FIGS. 15 and 16 show a side view and cross-sectional side view, respectively, of the hitch mount post 104 and an associated tightening plate 142 and the relationship to the hitch mount 202 of the vehicle 200. The hitch mount post 104 includes a mounting hole 172 that is aligned with a hole in the hitch mount 202 of the vehicle 200. A bolt 173 or pin may then be placed through those aligned holes to lock the transport rack 100 to the vehicle 200. To help avoid lateral movement of the hitch mount post 104 within the hitch mount 212, a shoulder bolt may be used where the shoulder of the shoulder bolt abuts a side wall of the hitch mount post 104 to limit lateral movement by forcing the hitch mount post 104 against an inner wall of the hitch mount 202. As shown in FIG. 16, the hitch mount post 104 may include such an inner wall 178 within the hitch mount post 104.

The tightening plate 142 may be included to remove vertical and rotational movement of the hitch mount post 104 relative to the hitch mount 202. The tightening plate may be attached in a conventional manner, such as using U-bolts that pass over the hitch mount post 104 and through the tightening plate to squeeze the tightening plate against both the hitch mount 202 and the hitch mount post 104.

Alternatively, the tightening plate 142 may be attached as shown in FIG. 16, where a threaded insert 170 is present within the hitch mount post 104. The threaded insert 170 may be welded in place within the hitch mount post 104. A tightening bolt 144 is then passed through a hole in the tightening plate and a hole 171 in the hitch mount post 104 so that the tightening bolt 144 engages the threads of the insert 170 to tighten the tightening plate 142 against both the hitch mount 202 and hitch mount post 104.

In either case, the tightening plate 142 reduces the likelihood of vertical and rotational movement of the hitch mount post 104. While the hitch mount post 104 may only move a small amount without the tightening plate 142 installed, this can result in a large amount of movement of the end of an elongated item loaded on the transport rack 100 such that removing this movement of the hitch mount post 104 can be helpful to reduce movement of the elongated item.

The transport rack 101 may also accommodate additional transport racks or other hitch mount accessories like those shown in FIGS. 1B and 1C. This is achieved by the hitch mount post 104 providing a hitch mount opening 146 that receives a hitch mount post of a second hitch mount accessory. In the example shown, the opening 146 is smaller than the opening of the hitch mount 202 of the vehicle 200 so that the accessory being attached to the opening 146 has a smaller hitch mount post than the hitch mount post 104. It will be appreciated that the hitch mount post 104 may be designed to provide an opening 146 that is of the size as the opening of the hitch mount 202 of the vehicle. A hole 176 may receive a mounting bolt, such as the shoulder bolt discussed above to secure the accessory to the transport rack 100.

The various components of the transport rack 100 may be constructed of various materials. For instance, the hitch mount post 104, vertical support post 102, center post 120, cross-member supports 122, 124, and L-catches may all be constructed of material such as steel. Other materials may also be applicable, including aluminum, titanium, and stainless steel. In the case of materials subject to corrosion, a surface treatment may be applied such as a powder coating or paint. Conventional bolts and eyelets may be used in the construction. In one example, the pivot bolt 114 may be of the type where threads are present only at the distal end away from the head of the bolt and outside of the rotation plate with the nut 113 being present on those threads. In this configuration, the rotation plates 110, 112 rest upon a rod portion of the bolt 114 that lacks the threads so that the threads and the rotation plates 110, 112 are not engaging.

From the above, it can be seen that embodiments of a transport rack 100 may have variations in construction and operation. However, the embodiments of the transport rack 100 provide for adjustability of the angle at which elongated items may be held on the transport rack 100 to thereby assist in hauling such elongated items behind a vehicle to which the transport rack 100 is attached.

While embodiments have been particularly shown and described, it will be understood by those skilled in the art that various other changes in the form and details may be made therein without departing from the spirit and scope of the invention.

What is claimed is:

1. An apparatus that can be affixed to a vehicle hitch mount to carry an elongated item, the apparatus comprising:
a support post;
a hitch mount post coupled to the support post at an angle;
a rotation plate rotationally coupled to the support post; and
a support structure coupled to the rotation plate such that the support structure and rotation plate rotate together relative to the support post.

2. The apparatus of claim 1, wherein the rotation plate includes multiple rotation position features, each rotation position feature corresponding to a rotational position of the rotation plate relative to the support post, and each rotation position feature allowing for locking the rotational position of the rotation plate.

3. The apparatus of claim 2, wherein the multiple rotation position features are arranged in an arc on the rotation plate, wherein the rotation plate has a centerpoint of rotation relative to the support post, and wherein a centerpoint of a radius of the arc is the centerpoint of rotation of the rotation plate.

4. The apparatus of claim 2, wherein the multiple rotation position features are holes in the rotation plate, the apparatus further comprising a lock pin that passes through one of the rotation position features and into a hole in the support post to lock the rotational position of the rotation plate.

5. The apparatus of claim 1, wherein the rotation plate is rotationally coupled to the support post by a pivot bolt passing through the rotation plate and into the support post.

6. The apparatus of claim 1, further comprising a second rotation plate, the support post being positioned between the rotation plate and the second rotation plate.

7. The apparatus of claim 6, wherein the second rotation plate includes multiple rotation position features, each rotation position feature of the second rotation plate corresponding to a rotational position of the second rotation plate relative to the support post, and each rotation position feature of the second rotation plate allowing for locking the rotational position of the second rotation plate, the multiple rotation position features of the second rotation plate being aligned relative to the multiple rotation position features of the rotation plate.

8. The apparatus of claim 1, wherein the support structure comprises a center post that is coupled to the rotation plate.

9. The apparatus of claim 1, wherein the support structure comprises a cross-member support coupled to the center post.

10. The apparatus of clam 9, wherein the support structure comprises a first L-shaped catch coupled to a first end of the cross-member support and a second L-shaped catch coupled to a second end of the cross-member support.

11. The apparatus of claim 10, wherein the first L-shaped catch has an adjustable position on the first end of the cross-member support and the second L-shaped catch has an adjustable position on the second end of the cross-member to allow an adjustable width between the first L-shaped catch and the second L-shaped catch.

12. The apparatus of claim 9, wherein the cross-member support is coupled to a first end of the center post, and wherein the support structure further comprises a second cross-member support coupled to a second end of the center post.

13. The apparatus of claim 1, further comprising a tightening plate coupled to the hitch mount post.

14. The apparatus of claim 13, further comprising a threaded insert present within the hitch mount post and a bolt that passes through a hole in the tightening plate and a hole in the hitch mount post with threads of the bolt engaging the threaded insert.

15. The apparatus of claim 1, further comprising a bolt that passes through the hitch mount post.

16. A method of making an apparatus that can be affixed to a vehicle hitch mount to carry an elongated item, the apparatus comprising:
providing a support post coupled to a hitch mount post at an angle;
rotationally coupling a rotation plate to the support post; and
coupling a support structure to the rotation plate such when the rotation plate is rotationally coupled to the support post, the support structure and rotation plate rotate together relative to the support post.

17. The method of claim 16, further comprising providing multiple rotation position features in the rotation plate, each rotation position feature corresponding to a rotational position of the rotation plate relative to the support post, and each rotation position feature allowing for locking the rotational position of the rotation plate.

18. The method of claim 16, further comprising rotationally coupling a second rotation plate to the support post, wherein the rotation plate and the second rotation plate are rotationally coupled to the support post by a pivot bolt passing through the rotation plate and into the support post and through the second rotation plate.

19. A method of using an apparatus that can be affixed to a vehicle hitch mount to carry an elongated item, wherein the apparatus comprises a support post; a hitch mount post coupled to the support post at an angle; a rotation plate rotationally coupled to the support post; and a support structure coupled to the rotation plate such that the support structure and rotation plate rotate together relative to the support post, the method comprising:
coupling the hitch mount post to the vehicle hitch mount;
setting the support structure together with the rotation plate to a rotational position relative to the support post; and
locking the rotational position of the rotation plate relative to the support post.

20. The method of claim 19, further comprising loading the elongated item onto the support structure.
